(19) United States
(12) Patent Application Publication
(10) Pub. No.: US 2009/0161226 A1
(43) Pub. Date: Jun. 25, 2009

(54) MOBILE PHONE

(75) Inventor: JEN-TSORNG CHANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/135,855

(22) Filed: Jun. 9, 2008

(30) Foreign Application Priority Data
Dec. 21, 2007 (CN) 200710203295.2

(51) Int. Cl. G02B 3/00

(52) U.S. Cl. 359/649

(57) ABSTRACT

A mobile phone (20) includes a main body, a camera module (300) mounted on the main body for capturing an image of a business card, and a projection module (400) mounted on the main body for projecting a collimating pattern on the business card to facilitate focusing of the camera module on the business card. The projection module includes a light source (122) for emitting light beams, a collimating lens (14) for collimating the light beams, a projection lens (18), and a projection film (16) disposed between the collimating lens and the projection lens. The projection film having a collimating pattern (160), the projection lens configured for projecting the collimating pattern onto the business card.

### BACKGROUND

1. Technical Field

The present invention relates to mobile phone systems, and particularly, to a mobile phone system with a miniaturized projection module for facilitating business card recognition function.

2. Discussion of Related Art

Portable electronic devices such as mobile phones and personal digital assistants (PDAs) are now in widespread use, and consumers may now enjoy the full convenience of high technology products almost anytime and anywhere.

Meanwhile, due to rapid development of businesses, most people use business cards to introduce themselves. The card file can be scanned and recognized by an image-capturing module and a character recognition module embedded in mobile phones or PDAs, and stored in them directly.

However, effects of the card recognition function may easily be influenced by some factors, such as the distance between the card and the image-capturing module, the area of the card taken by the image-capturing modules, etc.

Therefore, what is needed is a mobile phone with a projection module adapted for facilitating business card recognition function thereof.

### SUMMARY

A mobile phone includes a main body, a camera module mounted on the main body for capturing an image of a business card, and a projection module mounted on the main body for projecting a collimating pattern on the business card to facilitate focusing of the camera module on the business card. The projection module includes a light source for emitting light beams, a collimating lens for collimating the light beams, a projection lens, and a projection film disposed between the collimating lens and the projection lens. The projection film having a collimating pattern, the projection lens configured for projecting the collimating pattern onto the business card.

A mobile phone includes a image-capturing module including a capturing window, and a projection module including a projection window. The capturing window and the projection window are installed on the mobile phone and adjacent to each other. The projection module includes a shell, a light source, a collimating lens, a projection film, and a projection lens. The collimating lens, the projection film, and the projection lens, in the order written, are engagingly received in the shell. The collimating lens is facing to the light source. The light emitted from the light source transmits through the collimating lens, the projection film, the projection lens, and projects on the business card through the projection window.

### BRIEF DESCRIPTION OF THE DRAWINGS

Many aspects of the present projection module and mobile phone can be better understood with reference to the following drawings. The components in the drawings are not necessarily to scale, the emphasis instead being placed upon clearly illustrating the principles of the present projection module and mobile phone. Moreover, in the drawings, like reference numerals designate corresponding parts throughout the several views.

FIG. 1 is a schematic view of a projection module in accordance with a first embodiment.

FIG. 2 is a projection pattern in the projection module illustrated in FIG. 1.

FIG. 3 is a schematic view of a mobile phone in accordance with a second embodiment, in which a projection module according to the present invention is implemented.

FIG. 4 is a schematic, cross-sectional view of a projection module embedded in the mobile phone in FIG. 3.

FIG. 5 is a schematic, cross-sectional view of an alternative projection module embedded in the mobile phone in FIG. 3.

FIG. 6 is a schematic view of the card being projected by the projection module in accordance with the second embodiment.

### DETAILED DESCRIPTION OF PREFERRED EMBODIMENTS

Reference will now be made to the drawings to describe in detail of the preferred embodiments of the projection module and the mobile phone.

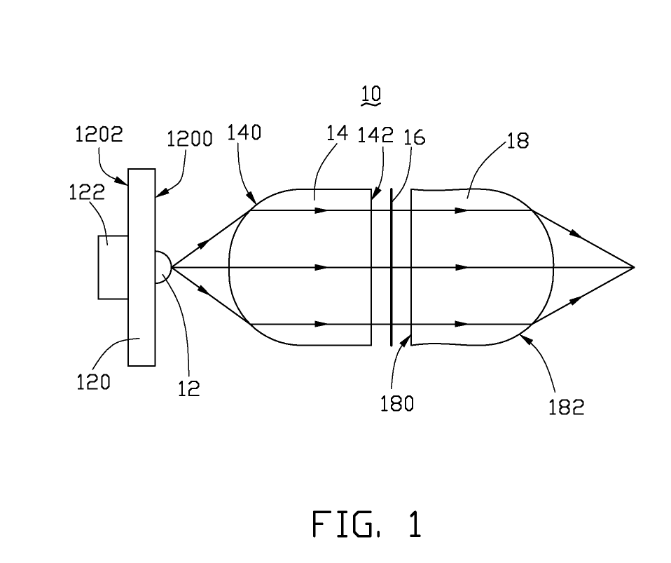

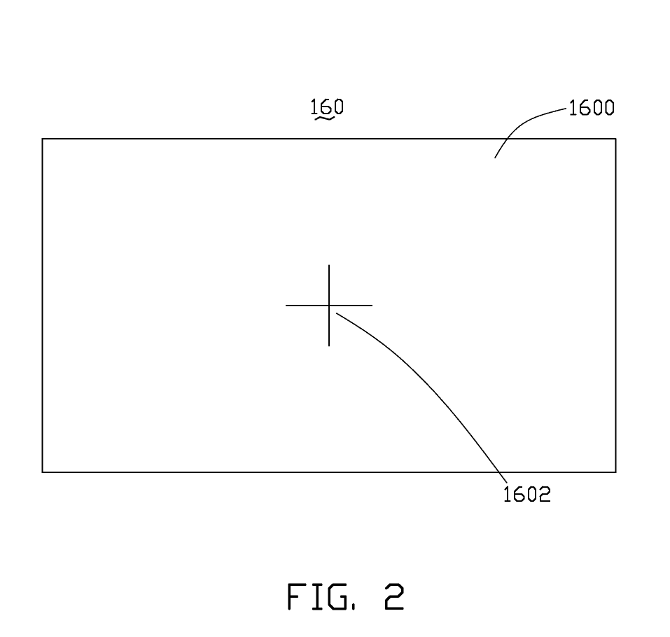

Referring to FIG. 1, a projection module 10, in accordance with a first embodiment, includes at least one light source 12. A collimating lens 14, a projection film 16, and a projection lens 18 are disposed along a path of the light emitted from the light source 12. The collimating lens 14 is adapted for collimating lights emitted from the light source 12. A projection pattern 160 (refer to FIG. 2) on the projection film 16 is illustrated by the collimated lights, and then projected through the projection lens 18.

The light source 12 is a dot light source. The light source 12 may be, for example, a light emitting diode (LED) or a laser diode (LD). In the present embodiment, the light source 12 is attached on one surface 1200 of a circuit board 120. The circuit board 120 can be made of copper or aluminum. The circuit board 120 made by copper or aluminum could increase the reflection of the lights. In the present embodiment, a heat sink 122 is attached on the other surface 1202 of the circuit board 120 facing away from the surface 1200. The heat sink 122 can be cooling grease. It is to be understood that the numbers and the types of the light source can vary depending on the application needs.

The collimating lens 14 is a positive lens having an incident surface 140 and a light emitting surface 142. The incident surface 140 faces to the light source 12. In the present embodiment, the incident surface 140 is a convex surface that curves or bulges outward, and the light emitting surface 142 is a plane surface. The incident surface 140 can be an aspherical surface. The collimating lens 14 can be a gradient rod lens.

The projection film 16 is disposed between the collimating lens 14 and the projection lens 18. The projection film 16 can be glued (i.e., adhesively mounted) to the collimating lens 14 or the projection lens 18.

Referring to FIG. 2, the projection pattern 160 is defined at the center of the projection film 16. In the present embodiment, the projection pattern 160 includes a rectangular frame 1600 and a cross 1602 in the center of the rectangular frame 1600. In alternative embodiments, the frame 1600 can be circular shaped, pentagon shaped, etc.

The projection lens 18 is a positive lens having an incident surface 180 and a light emitting surface 182. The incident surface 180 faces the projection film 18. In the present embodiment, the incident surface 180 is a plane surface, and the light emitting surface 182 is a convex surface.

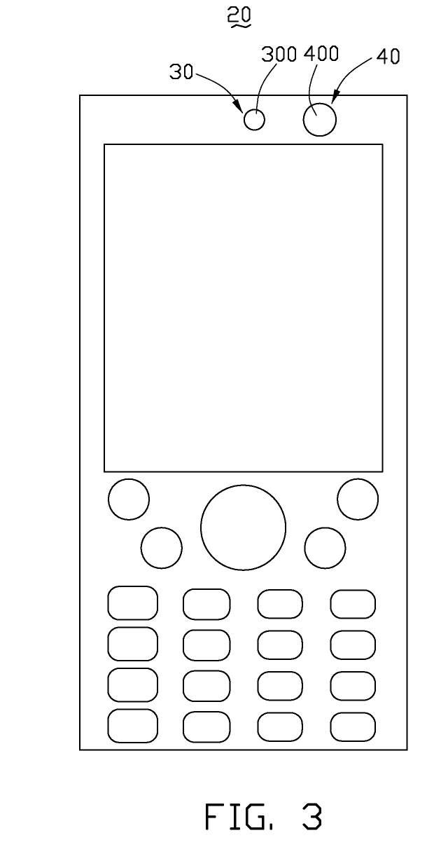

Referring to FIG. 3, a mobile phone 20, in accordance with a second embodiment, includes a projection module 30 and an image-capturing module 40. The projector module 30 has a window 300 and the image-capturing module 40 has a capturing window 400. The window 300 of the projection module 30 and the capturing window 400 of the image-capturing module 40 are both installed outside the mobile phone 20 and adjacent to each other. The mobile phone 20 further includes a character recognition module (not shown) installed inside the mobile phone 20 and connected to the image-capturing module 40 for transferring the image of the card captured by the image-capturing module 40 into character data and transmitting the character data to the mobile phone 20. The character recognition module can be an optical character recognition system (OCR system), which can extract characters from the image of the card captured by the image-capturing module 40, compare the characteristic of the characters with ones in the characteristic database, and at last transmit the corresponding characters to the mobile phone 20. The character recognition technology is in common use, so the detailed description is not being described.

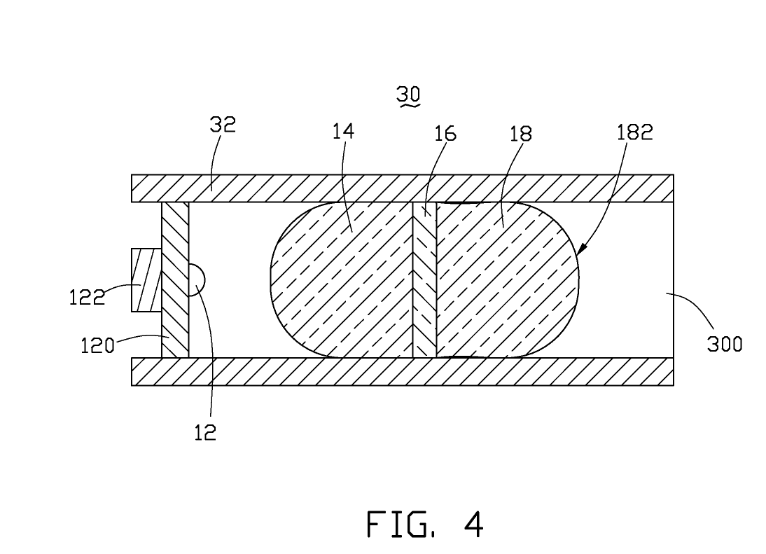

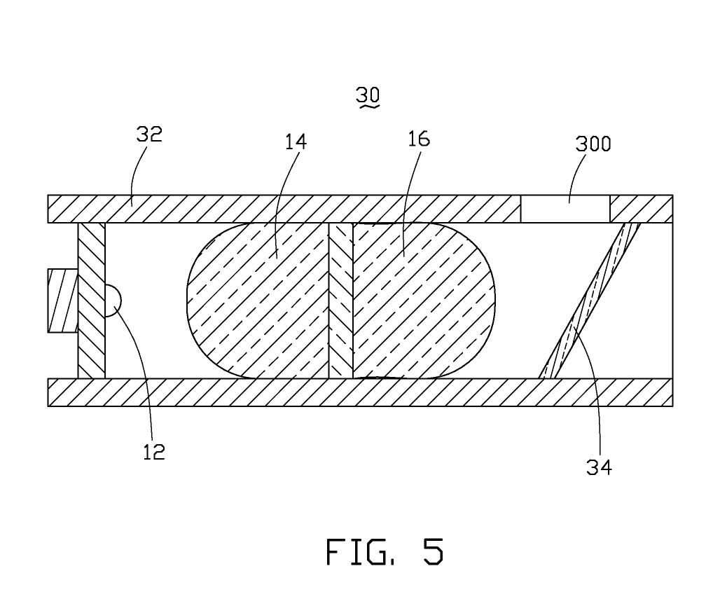

Referring to FIGS. 4 and 5, similar to that in the first embodiment, the projection module 30 includes a light source 12, a collimating lens 14, a projection film 16, and a projection lens 18. The light source 12 is attached on one surface 1200 of a circuit board 120. A heat sink 122 is attached on the other surface 1202 of the circuit board 120 facing away from the surface 1200. The difference is that the circuit board 120, the collimating lens 14, the projection film 16, and the projection lens 18 are engagingly received in a cylindrical shell 32. One end of the shell 32 opposite to the projection lens 18 is the window 300. The collimating lens 14 is adapted for collimating lights emitted from the light source 12. The projection pattern (not shown) on the projection film 16 is illustrated by the collimated lights, then projected through the projection lens 18, and then the image is projected on the card through the window 300.

Referring to FIG. 5, the projection module 30 further includes a reflection plate 34 opposite to the projection module. The reflection plate 34 and the path of the light emitted from the light source 12 intersect at a 45-degree angle. The window 300 is set on the sidewall of the shell 32. The reflection plate 34 is adapted for reflecting the image of the projection pattern towards the window 300. The reflected image is projected on the card through the window 300.

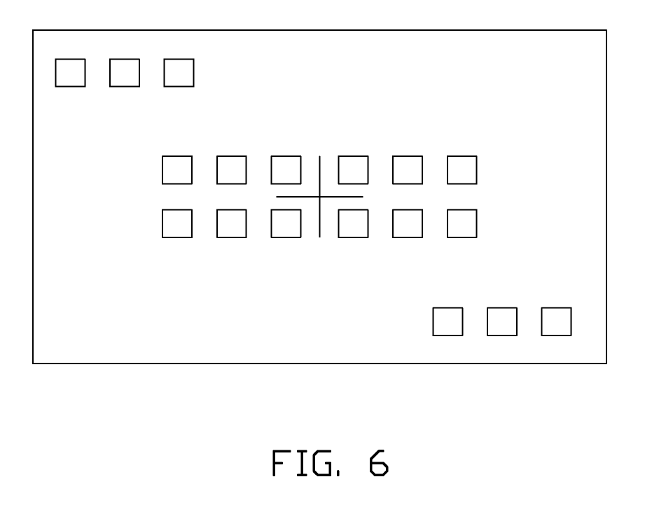

In operation, the projection module 30 is adapted for projecting an image of the projection pattern on a business card. User can adjust relative position between the projection of the frame and the card, until the projection of the frame completely cover the entire area of a business card so as to align the image-capturing module 40 with the card for improving quality of the capturing image (referring to FIG. 6).

While the present invention has been described as having preferred or exemplary embodiments, the embodiments can be further modified within the spirit and scope of this disclosure. This application is therefore intended to cover any variations, uses, or adaptations of the embodiments using the general principles of the invention as claimed. Further, this application is intended to cover such departures from the present disclosure as come within known or customary practice in the art to which the invention pertains and which fall within the limits of the appended claims or equivalents thereof.

What is claimed is:

1. A mobile phone comprising:
a main body,
a camera module mounted on the main body for capturing an image of a business card;
a projection module mounted on the main body for projecting a collimating pattern on the business card to facilitate focusing of the camera module on the business card, the projection module comprising
a light source for emitting light beams,
a collimating lens for collimating the light beams,
a projection lens, and
a projection film disposed between the collimating lens and the projection lens, the projection film having a collimating pattern, the projection lens configured for projecting the collimating pattern onto the business card.

2. The mobile phone as described in claim 1, wherein the light source is a light emitting diode or a laser diode.

3. The mobile phone as described in claim 1, further comprising a circuit board having two surfaces opposite to each other.

4. The mobile phone as described in claim 3, wherein the light source is attached on one of the surfaces of the circuit board.

5. The mobile phone as described in claim 4, further comprising a heat sink being attached on the other surface of the circuit board.

6. The mobile phone as described in claim 5, wherein the heat sink includes cooling grease.

7. The mobile phone as described in claim 3, wherein the circuit board is comprised of copper or aluminum.

8. The mobile phone as described in claim 1, wherein the collimating lens is a positive lens with a positive fraction power, the collimating lens having an incident surface and a light emitting surface, the incident surface facing to the light source.

9. The mobile phone as described in claim 8, wherein the incident surface is a convex surface, and the light emitting surface is a plane surface.

10. The mobile phone as described in claim 8, wherein the incident surface is an aspherical surface.

11. The mobile phone as described in claim 1, wherein the collimating lens is a gradient index lens.

12. The mobile phone as described in claim 1, wherein the projection pattern comprises a rectangular frame and a cross in the center thereof.

13. A mobile phone comprising:
an image-capturing module including a capturing window,
a projection module including a projection window, the capturing window and the projection window being adjacent to each other;
the projection module comprising:
a housing,
a light source for emitting light, a collimating lens, a projection film having a collimating pattern, and a projection lens, arranged in the order written, and engagingly received in the housing, the collimating lens facing to the light source.

14. The mobile phone as described in claim 13, wherein the projection window is set on the housing.

15. The mobile phone as described in claim 13, further comprising a reflection plate for directing the light from the light source to exit through the projection window.

16. The mobile phone as described in claim 13, further comprising a circuit board having two surfaces opposite to each other.

17. The mobile phone as described in claim 16, wherein the light source is attached on one surface of the circuit board.

18. The mobile phone as described in claim 17, further comprising a heat sink attached on the other surface of the circuit board.

19. The mobile phone as described in claim 16, wherein a material of the circuit board is copper or aluminum.

20. The mobile phone as described in claim 13, wherein the projection pattern comprises a rectangular frame and a cross in the center thereof.
